(19) United States
(12) Patent Application Publication
(10) Pub. No.: US 2020/0356724 A1
(43) Pub. Date: Nov. 12, 2020

(54) MULTI-HOP ATTENTION AND DEPTH MODEL, METHOD, STORAGE MEDIUM AND TERMINAL FOR CLASSIFICATION OF TARGET SENTIMENTS

(71) Applicant: UNIVERSITY OF ELECTRONIC SCIENCE AND TECHNOLOGY OF CHINA, Chengdu (CN)

(72) Inventors: Xiaoyu LI, Chengdu (CN); Desheng ZHENG, Chengdu (CN); Yu DENG, Chengdu (CN)

(21) Appl. No.: 16/868,179

(22) Filed: May 6, 2020

(30) Foreign Application Priority Data
May 6, 2019 (CN) 201910370891.2

(51) Int. Cl. G06F 40/284; G06N 3/04; G06N 3/08

(52) U.S. Cl. CPC G06F 40/284; G06N 3/08; G06N 3/0454

(57) ABSTRACT

The invention discloses a multi-hop attention and depth model, method, storage medium and terminal for classification of target sentiments. In said model, the combined two-dimensional lexical features (matrix3) produced by the first convolution operation module are used in each hop of attention calculation module and the attention weight information is continuously transmitted to sublayers; before calculation in the last hop, the one-dimensional lexical features input are weighted (by lexical vector weighting module) in the model with the attention (the first attention calculation module) before convolution operation (the second convolution operation module), to generate the weighted combined two-dimensional lexical features (matrix4) to be used in the final attention calculation.

### FIELD OF THE INVENTION

The invention discloses a multi-hop attention and depth model, method, storage medium and terminal for classification of target sentiments.

### BACKGROUND OF THE INVENTION

Sentiment analysis or opinion mining represents calculation and study of people's opinions, sentiments, feelings, evaluations and attitudes about products, services, organizations, individuals, problems, incidents and topics and attributes thereof. How to use natural language processing (NLP) technology to execute sentiment analysis on the subjective opinion texts is being concerned by more and more researchers. The target-oriented fine-grained sentiment analysis, as a subtask of sentiment analysis, can, aiming at specific objects, effectively explore the deep sentiment features in the context, and has already become a hot-spot issue for study in the field.

Classification of sentiments is of an aspect-level issue. When training set and test set are for different targets, the method of classification based on supervised learning generally shows a poor result. Therefore, study on target-oriented fine-grained sentiment classification appears to have a more practical significance, and target can refer to specific lexes in the context, and also to the abstract objects or fields of text descriptions. Currently, many researchers apply attention mechanism to the field of classification for target sentiments, with good outcomes achieved. With the currently available technology, on the LSTM network, the target contents are spliced with corresponding intermediate states in the sequences, and attention weight output is calculated, so that the issue of sentiment polarity for different targets in the context can be solved effectively. With other currently available technologies, a multi-hop attention model is put forward with reference to the depth memory network, and values of attention based on contents and positions are calculated, for fully exploring the sentiment features information for specific objects in the context. In such other currently available technologies, the attention mechanism is applied to the model integrating regional convolution neural network with LSTM, so that not only the temporal dependency of input sequences is retained, but also the training efficiency is improved. In such other currently available technologies, multiple attention mechanisms are integrated with the convolution neural network, so that the analysis effect of target sentiments can be improved from a comprehensive perspective of lexical vector, lexical features and position information.

However, the currently available technologies are based on attention of one-dimensional features, which can only represent information of single lexis, so the entire model may lose the information of semantics in the context such as phrases and expressions when processing data, which may drop the features of classification, while the combined multi-dimensional features can explore a more abstract presentation of information at a higher level by use of richer semantic expressions. Therefore, the invention discloses a depth model and method integrating multi-hop attention mechanism with convolution neural network without dependency on such priori knowledge as syntactic analysis, grammatical analysis and sentiment lexicon, to settle the problem to be solved urgently in the field (disadvantages in attention mechanism with one-dimensional features) by use of combined multi-dimensional features.

### SUMMARY OF THE INVENTION

The invention discloses a multi-hop attention and depth model, method, storage medium and terminal for classification of target sentiments, for the purposes of overcoming the disadvantages in the currently available technologies and solving the problem that the attention mechanism with one-dimensional features in the currently available technologies can only represent the information of single lexis and that the entire model may lose the information of semantics in the context such as phrases and expressions when processing data to drop the features of classification.

The object of the invention is realized by means of the following technical solution: Firstly, the invention discloses a multi-hop attention and depth model for classification of target sentiments, with inputs including lexical vector matrix (matrx1) and target lexical vector (aspect) (lexical vector matrix (matrx1) represented as V={V₁, V₂, V₃, . . . , Vₙ}), wherein said model includes:

A first convolution operation module, for executing one-dimensional convolution operation to lexical vector matrix (matrix1) to generate vector matrix of combined adjacent lexical features (matrix3);

A first attention calculation module, for calculating the attention weight vector of the lexical vector matrix (matrix1) for target lexical vector (aspect), wherein the attention weight vector is represented as α={α₁, α₂, α₃, . . . , αₙ};

A lexical vector weighting module, for executing operation ⊗ for the lexical vector matrix (matrix1) with the obtained attention weight vector, to obtain the attention-weighted lexical vector matrix (matrix2), wherein the operation ⊗ is defined as: V⊗α={α₁·V₁, α₂·V₂, α₃·V₃, . . . , αₙ·Vₙ};

A second convolution operation module, for executing the one-dimensional convolution operation for the attention-weighted lexical vector matrix (matrix2), to generate vector matrix of weighted combined adjacent lexical features (matrix4);

Multiple attention calculation layers (hop) connected in sequence. All of the attention calculation layers (hop) are in the same structure, including:

An attention calculation unit, for calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation layer (hop), wherein the first attention calculation layer (hop1) is for the attention weight vector of the target lexical vector (aspect) while the rest of the attention calculation layers (hopm) are for new target lexical vector (aspect′) output from the previous attention calculation layer (hopm−1).

An attention weighting unit, for executing the operation ⊙ for the vector matrix of combined adjacent lexical features (matrix3) and attention weight vector obtained by the attention calculation unit, to obtain attention weight and vector, wherein operation ⊙ is defined as: V⊙α=V·a=Σᵢ₌₁ⁿαᵢ·Vₙ;

A new target lexical vector generation unit, for executing operation ⊕ for the attention weight vector obtained by the attention weighting unit and the target lexical vector (aspect), or executing operation ⊕ for the attention weight vector obtained by the attention weighting unit and the attention weight vector of new target lexical vector (aspect′) output from the previous attention calculation layer (hop), wherein the operation ⊕ is defined as: α⊕β=α+β; the first attention calculation layer (hop1) is for the target lexical vector (aspect) while the rest of the attention calculation layers (hopm) are for new target lexical vector (aspect′) output from the previous attention calculation layer (hopm−1);

Said model also includes:

A second attention calculation module, for calculating the attention weight vector of vector matrix of weighted combined adjacent lexical features (matrix4) for new target lexical vector (aspect′) output from the last attention calculation layer (hop);

An attention weighting module, for executing operation ⊙ for vector matrix of weighted combined adjacent lexical features (matrix4) and attention weight vector obtained by the second attention calculation module, to obtain attention weight and vector;

A fully connected layer, for representing the attention weight and vector output from the attention weighting module as the final vector of input text, wherein the predict outcomes for classification of sentiments can be obtained through this fully connected layer.

Further, any calculation mode for calculating the attention weight vector of lexical vector matrix for target lexical vector or calculating attention weight vector of feature vector matrix for target lexical vector is:

$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$

Where W represents target lexical vector, V represents lexical vector matrix or feature vector matrix, U represents weight matrix and b represents offset vector;

After this, SoftMax function is used for normalization of correlation scores of all inputs, and the originally calculated scores are converted into a probability distribution with the sum of weights of all elements being 1:

$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$

Where exp represents an exponential function with e as base.

Further, the model also includes:

A pre-processing module, for pre-training the lexes in the input texts by means of word2vec or Glove algorithm and converting them into lexical vectors, and then forming a two-dimension matrix with the lexical vectors in a lexical order to obtain the lexical vector matrix (matrix1).

Further, the one-dimensional convolution operation of the convolution operation module comprises:

Sliding multiple filters k on the whole line of the lexical vector matrix, to finally generate the feature vector representing adjacent poly-lexical combinations in the sliding window, i.e. the vector matrix of combined adjacent lexical features, with a calculation formula of:

FM=ƒ(w·x+b)

Where w represents weight matrix of filter, x represents lexical vector matrix input in the filter window, b represents offset and f represents activation function of filter.

Secondly, the invention discloses a method for classification of target sentiments by use of multi-hop attention and depth model with inputs including lexical vector matrix (matrx1) and target lexical vector (aspect) (lexical vector matrix (matrx1) represented as V={V₁, V₂, V₃, . . . , Vₙ}). Said method comprises the following steps:
S11: calculating the attention weight vector of the lexical vector matrix (matrix1) for target lexical vector (aspect), wherein the attention weight vector is represented as α={α₁, α₂, α₃, . . . , αₙ};

S12: executing operation ⊗ for lexical vector matrix (matrix1) and obtained attention weight vector to obtain attention-weighted lexical vector matrix (matrix2), wherein operation ⊗ is defined as: V⊗α={α₁·V₁, α₂·V₂, α₃·V₃, . . . , αₙ·Vₙ};

S13: executing the one-dimensional convolution operation for the attention-weighted lexical vector matrix (matrix2), to generate vector matrix of weighted combined adjacent lexical features (matrix4);

S21: executing the one-dimensional convolution operation for the lexical vector matrix (matrix1), to generate vector matrix of combined adjacent lexical features (matrix3);

S22: calculating attention in multiple hops, wherein the same calculation mode is adopted for attention calculation in each hop, including:

S221: calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation, wherein the first attention calculation is for the attention weight vector of the target lexical vector (aspect) while the rest of the attention calculations are for new target lexical vector (aspect′) output from the previous attention calculation (hopm−1);

S222: executing the operation ⊙ for the vector matrix of combined adjacent lexical features (matrix3) and attention weight vector obtained in step S221, to obtain attention weight and vector, wherein operation ⊙ is defined as: V⊙α=V⊙α=Σᵢ₌₁ⁿαᵢ·Vₙ;

S223: executing operation ⊕ for the attention weight vector obtained in step S222 and the target lexical vector (aspect), or executing operation ⊕ for the attention weight vector obtained in step S02 and the attention weight vector of new target lexical vector (aspect′) output from the previous attention calculation (hopm−1), wherein the operation ⊕ is defined as: α⊕β=α+β; the first attention calculation (hop1) is for the target lexical vector (aspect) while the rest of the attention calculations (hopm) are for new target lexical vector (aspect′) output from the previous attention calculation (hopm−1);

Said method further includes:

S31: calculating the attention weight vector of vector matrix of weighted combined adjacent lexical features (matrix4) for new target lexical vector (aspect′) output from the last attention calculation (hop);

S32: executing the operation ⊙ for the vector matrix of weighted combined adjacent lexical features (matrix4) and attention weight vector obtained in step S31, to obtain attention weight and vector;

S33: representing the attention weight and vector obtained in step S32 as the final vector of input text, wherein the predict outcomes for classification of sentiments can be obtained through this fully connected layer.

Further, any calculation mode for calculating the attention weight vector of lexical vector matrix for target lexical vector or calculating attention weight vector of feature vector matrix for target lexical vector is:

$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$

Where W represents target lexical vector, V represents lexical vector matrix or feature vector matrix, U represents weight matrix and b represents offset vector;

After this, SoftMax function is used for normalization of correlation scores of all inputs, and the originally calculated scores are converted into a probability distribution with the sum of weights of all elements being 1:

$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$

Where exp represents an exponential function with e as base.

Further, said method also includes:

Pre-training the lexes in the input texts by means of word2vec or Glove algorithm and converting them into lexical vectors, and then forming a two-dimension matrix with the lexical vectors in a lexical order to obtain the lexical vector matrix (matrix1).

Further, the one-dimensional convolution operation comprises: Sliding multiple filters k on the whole line of the lexical vector matrix, to finally generate the feature vector representing adjacent poly-lexical combinations in the sliding window, i.e. the vector matrix of combined adjacent lexical features, with a calculation formula of:

FM=ƒ(w·x+b)

Where w represents weight matrix of filter, x represents lexical vector matrix input in the filter window, b represents offset and f represents activation function of filter.

Thirdly, the invention discloses a storage medium, storing computer instructions, wherein the steps of a method for classification of target sentiments by use of multi-hop attention and depth model are executed when said computer instructions are executed.

Fourthly, the invention discloses a terminal, including a storage medium and a processor, computer instructions that can be operated in the processor are stored in the storage medium, wherein the steps of a method for classification of target sentiments by use of multi-hop attention and depth model are executed when said computer instructions are executed by said processor.

The invention has the following beneficial effects:

The invention, aiming at the issue of field-oriented fine-grained sentiment classification, discloses a multi-hop attention and depth model integrating convolution neural network with memory network. The model can make use of the features of semantic expressions by adjacent lexes in the Chinese context and use combined multi-dimensional features as a supplement to the attention mechanism with one-dimensional features. Moreover, with an architecture overlapped with multiple calculation layers, the model can also obtain deeper features information of target sentiments, and effectively solve the issue of long-distance dependency.

In addition, in the multi-hop attention and depth model disclosed in the invention, the combined two-dimensional lexical features (matrix3) produced by the first convolution operation module are used in each hop of attention calculation module and the attention weight information is continuously transmitted to sublayers. Before calculation in the last hop (before calculation by the second attention calculation module), the one-dimensional lexical features input are weighted (by lexical vector weighting module) in the model with the attention (the first attention calculation module) before convolution operation (the second convolution operation module), to generate the weighted combined two-dimensional lexical features (matrix4) to be used in the final attention calculation. Through the operations above, the model has the attention weight information with both the one-dimension and the two-dimensional lexical features, so it can make full use of the attention mechanism to extract and learn more hidden information about the target in a multi-dimensional feature space, to better predict the sentiment polarities based on different targets.

Corresponding issues are also solved by the method, storage medium and terminal disclosed in the invention.

### DESCRIPTION OF THE DRAWINGS

FIG. 1 is the connection diagram of an exemplary embodiment in the invention;

FIG. 2 is the attention calculation diagram of an exemplary embodiment in the invention;

FIG. 3 is the convolution operation diagram of an exemplary embodiment in the invention;

FIG. 4 is the classification accuracy diagram under different convolution windows during experimental process of an exemplary embodiment in the invention.

### DETAILED DESCRIPTION OF THE PREFERRED EMBODIMENTS

In the following exemplary embodiments, a multi-hop attention and depth model and method integrating attention mechanism with convolution neural network is disclosed in order to solve issue of target-oriented fine-grained sentiment classification. The ideas and details of implementation of the model and method, including overviews of the model and method, combined multi-dimensional attention design and multi-hop attention structure are described in the following exemplary embodiments.

The model consists of multiple calculation layers to obtain deeper features information of target sentiments. Each layer includes an attention model based on target contents for learning the feature weights of adjacent lexical combinations in the context, and the last layer is for calculating the continuous text representation as the final features of sentiment classification.

Firstly unstructured texts are converted into structured numeric vectors to facilitate the processing. One sentence including n lexes can be converted into S={v₁, v₂, v₃, v₄, . . . , vₙ}, wherein vᵢ∈R^{m}, representing the m-dimension vector representation of No. i lexis; S∈R^{n*m} representing the input lexical vector matrix of sentence. However, target-oriented sentiment polarity in the sentence can be represented as the following expression, wherein w∈R^{m}, representing m-dimension vector representation of polarity for the target.

polarity=ƒₚₒₗₐᵣ(S,w)

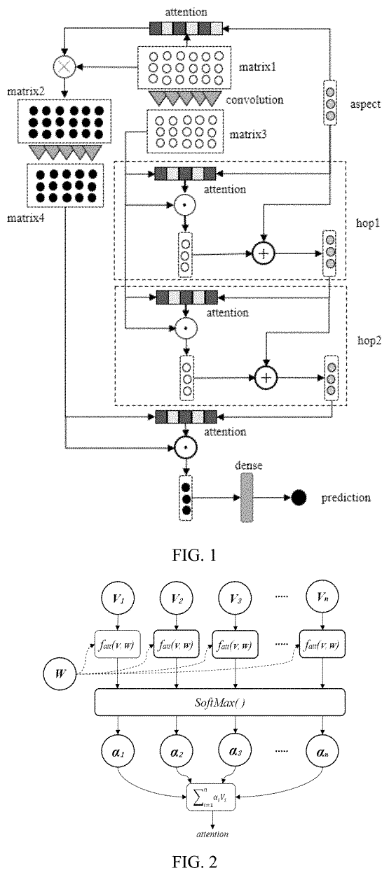

Refer to FIG. 1. FIG. 1 is a diagram of a multi-hop attention and depth model for classification of target sentiments as indicated in an exemplary embodiment in the invention, wherein the model includes multiple convolution operation modules and multiple attention calculation layers, for better learning deeper features information from the input text sequences for different targets.

Assuming V={V₁, V₂, V₃, . . . , Vₙ}, representing lexical vector matrix; α={α₁, α₂, α₃, . . . , αₙ}, representing attention weight vector; then the three kinds of calculation and operation are defined as follows.

$$\{ \begin{matrix}V ⊙ α = V \cdot α = {\sum }_{i = 1}^{n} {α}_{i} \cdot {V}_{n} \\ V ⊗ α = \{ {α}_{1} \cdot {V}_{1} , {α}_{2} \cdot {V}_{2} , {α}_{3} \cdot {V}_{3} , … , {α}_{n} \cdot {V}_{n} \} \\ α ⊕ β = α + β\end{matrix}$$

The inputs of the model include lexical vector matrix (matrx1) and target lexical vector (aspect) (lexical vector matrix (matrx1) represented as V={V₁, V₂, V₃, . . . , Vₙ}).

In the following exemplary embodiments, the three kinds of calculation and operation involved in the model are described, and the model is described from top layer to bottom layer. Specifically, said model includes:

(1) Two convolution operation modules for pre-processing the input lexical vector matrix at the top layer.

On one hand, the model includes a first convolution operation module, for executing one-dimensional convolution operation to lexical vector matrix (matrix1) to generate vector matrix of combined adjacent lexical features (matrix3).

On the other hand, the model includes a first attention calculation module, for calculating the attention weight vector of the lexical vector matrix (matrix1) for target lexical vector (aspect), wherein the attention weight vector is represented as α={α₁, α₂, α₃, . . . , αₙ};

The model also includes a lexical vector weighting module, for executing operation ⊗ for the lexical vector matrix (matrix1) with the obtained attention weight vector, to obtain the attention-weighted lexical vector matrix (matrix2), wherein the operation ⊗ is defined as: V⊗α={α₁·V₁, α₂·V₂, α₃·V₃, . . . , αₙ·Vₙ};

The model includes a second convolution operation module, for finally executing the one-dimensional convolution operation for the attention-weighted lexical vector matrix (matrix2), to generate vector matrix of weighted combined adjacent lexical features (matrix4).

(2) From top layer to bottom layer, the model includes multi-hop attention calculation layers, specifically:

Multiple attention calculation layers (hop) connected in sequence. All of the attention calculation layers (hop) are in the same structure, including:

An attention calculation unit, for calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation layer (hop), wherein the first attention calculation layer (hop1) is for the attention weight vector of the target lexical vector (aspect) while the rest of the attention calculation layers (hopm) are for new target lexical vector (aspect′) output from the previous attention calculation layer (hopm−1).

An attention weighting unit, for executing the operation ⊙ for the vector matrix of combined adjacent lexical features (matrix3) and attention weight vector obtained by the attention calculation unit, to obtain attention weight and vector, wherein operation ⊙ is defined as: V⊙α=V·α=Σᵢ₌₁ⁿαᵢ·Vₙ;

A new target lexical vector generation unit, for executing operation ⊕ for the attention weight vector obtained by the attention weighting unit and the target lexical vector (aspect), or executing operation ⊕ for the attention weight vector obtained by the attention weighting unit and the attention weight vector of new target lexical vector (aspect′) output from the previous attention calculation layer (hop), wherein the operation ⊕ is defined as: α⊕β=α+β; the first attention calculation layer (hop1) is for the target lexical vector (aspect) while the rest of the attention calculation layers (hopm) are for new target lexical vector (aspect′) output from the previous attention calculation layer (hopm−1).

Specifically, the first attention calculation layer (hop) is for calculating the attention weight vector of matrix3 for the target vector and executing operation ⊙ for matrix3 and obtained weight vector, to obtain an attention weight and vector, and then executing operation ⊕ for such attention weight and vector with aspect, to generate new target vector. The attention calculation layers can be continuously stacked and the calculation steps above can be repeated. However, the target vector for calculation of attention weight is no longer the original target lexical vector (aspect), but to be provided by the previous calculation layer.

In this exemplary embodiment, only the situation in which there are two attention calculation layers (hop) is indicated, as shown in FIG. 1. The situation in which there are more attention calculation layers (hop) can be inferred as described above.

(3) The Last Calculation Layer of the Model Includes:

A second attention calculation module, for calculating the attention weight vector of vector matrix of weighted combined adjacent lexical features (matrix4) for new target lexical vector (aspect′) output from the last attention calculation layer (hop);

An attention weighting module, for executing operation ⊙ for vector matrix of weighted combined adjacent lexical features (matrix4) and attention weight vector obtained by the second attention calculation module, to obtain attention weight and vector;

A fully connected layer, for representing the attention weight and vector output from the attention weighting module as the final vector of input text, wherein the predict outcomes for classification of sentiments can be obtained through this fully connected layer.

The design and use of the features play a very significant role in machine learning. However, a simple dependency on increase in number of features cannot effectively break through the limit performance of predict of the model. In a task of processing natural language, generally the lexicon produced from corpus is used as the input of the model. However, this kind of visual features at a shallower level is inadequate for expression of implicated relationship. Appropriate introduction of phrases and expressions and conversion of input into model from shallower features to deeper features will bring more semantic information, to explore deeper interactive features in the context.

Generally, in the Chinese context, single lexis has different meanings. For example, an adjective, when being used to describe different nouns, generally reflects different sentiment orientations, and in this case, the clear sentiment polarity can only be expressed with the semantic features combined from adjacent lexes. However, the convolution neural network can use convolution kernel to execute convolution operation for multiple adjacent lexes in the text, to produce semantic features of phrases, with local lexical sequence information between the originally input lexes retained.

However, the attention mechanism in this exemplary embodiment is for the model to learn the importance of the input data during the training process, and to focus on more important information.

In the multi-hop attention and depth model disclosed in the exemplary embodiment, the combined two-dimensional lexical features (matrix3) produced by the first convolution operation module are used in each hop of attention calculation module and the attention weight information is continuously transmitted to sublayers. Before calculation in the last hop (before calculation by the second attention calculation module), the one-dimensional lexical features input are weighted (by lexical vector weighting module) in the model with the attention (the first attention calculation module) before convolution operation (the second convolution operation module), to generate the weighted combined two-dimensional lexical features (matrix4) to be used in the final attention calculation. Through the operations above, the model has the attention weight information with both the one-dimension and the two-dimensional lexical features, so it can make full use of the attention mechanism to extract and learn more hidden information about the target in a multi-dimensional feature space, to better predict the sentiment polarities based on different targets.

The multi-dimensional features above refer to that the original inputs into the model are taken as one set of single features and adjacent features are combined in pairs via calculation into new two-dimensional phrase features to be used together with those single features, also referred to as combined multi-dimensional features. The previous information can be kept no matter what change is made after the original inputs are weighted as the features in the deep learning model are transferable, that is, the features produced after convolution contain the weight information in the original lexes as model can execute parameter learning via backward gradient transfer.

Moreover, in a deep model in this embodiment, the attention mechanism of single calculation layers is of a function of weighted synthesis in nature, for calculating useful context information, then outputting and transferring the function to the next layer, and referring to the history of attention in the previous layer in the next hop of attention calculation, i.e. taking into account the previous attention to lexes. By means of multi-hop attention calculation, the deep network can learn the text representation in multiple layers of abstraction, wherein important lexes in the context are searched in each layer and the representation output from the previous layer is converted to a higher and more abstract layer. For a special target, through attention stacking and conversion for a sufficient number of hops, the sentence learned and obtained by the model can be expressed with more complicated and abstract non-linear features.

The model structures of each hop are completely same. However, parameters will be automatically learned in each hop, which brings about a difference in the internal parameters, so there is no mode of sharing the weight parameters.

Modeling of the relationship of transfer between long-distance lexes and description of dependency between them are always critical to the system performance. Currently, recursive neural network model is an effective means to solve the long-distance dependency. The multi-hop attention model in this embodiment is a depth memory neural network using a recursive architecture, with its storage cells already extended from scalar storage to vector storage, which is different from LSTM and GRU networks. The model accesses the external storage cells in each hop of attention calculation. The external storage cells will be read for many times before output, so that all input elements can be fully interacted by virtue of the recursive calculation process of attention in multiple calculation layers of the model. In comparison to the recurrent network of a chain structure, the multi-hop attention model together with external storage cells can capture the remote dependency in a shorter path by means of end-to-end training.

Preferably, in this embodiment, the calculation mode of attention mechanism is as follows: The calculation process of attention mechanism in NLP task, as shown in FIG. 2, comprises firstly calculating the correlation of each input (v) for specific task target (w) through correlation function fₐₜₜ; secondly normalizing the original scores to obtain a weight coefficient; finally weighting and summing the inputs according to the weight coefficient to obtain the final attention value.

For calculation of correlation between input and target, different functions and mechanisms can be introduced, and the method comprises: solving the vector dot product of the input and target, splicing the vectors of them and introducing additional neural networks for evaluation or to solve the cosine similarity between vectors of them, as specifically described as follows. In this exemplary embodiment, the model can have more training parameters by means of splicing operation, to explore deeper features information. Splicing operation here refers to that two vectors are spliced end to end to form a vector in a higher dimension.

Any calculation mode for calculating the attention weight vector of lexical vector matrix for target lexical vector or calculating attention weight vector of feature vector matrix for target lexical vector is:

$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$

Where W represents target lexical vector, V represents lexical vector matrix or feature vector matrix, U represents weight matrix and b represents offset vector; weight matrix U represents the parameters initialized as per certain rules on the neural network, is random and does not need to be manually controlled; the training of neural network is actually of a process of continuous updating for the weight matrix;

For the purpose of extracting deeper features information, SoftMax function is then used to normalize the correlation scores of all inputs, and the originally calculated scores are converted into a probability distribution with the sum of weights of all elements being 1:

$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$

Where exp represents an exponential function with e as base. Moreover, the weight of important elements can be highlighted.

Preferably, in this embodiment, said model also includes:

A pre-processing module, for pre-training the lexes in the input texts by means of word2vec or Glove algorithm and converting them into lexical vectors, and then forming a two-dimension matrix with the lexical vectors in a lexical order to obtain the lexical vector matrix (matrix1).

Preferably, in this embodiment, said one-dimensional convolution operation of the convolution operation module comprises:

Sliding multiple filters k on the whole line of the lexical vector matrix, to finally generate the feature vector representing adjacent poly-lexical combinations in the sliding window, i.e. the vector matrix of combined adjacent lexical features, with a calculation formula of:

FM=ƒ(w·x+b)

Where w represents weight matrix of filter, x represents lexical vector matrix input in the filter window, b represents offset and f represents activation function of filter.

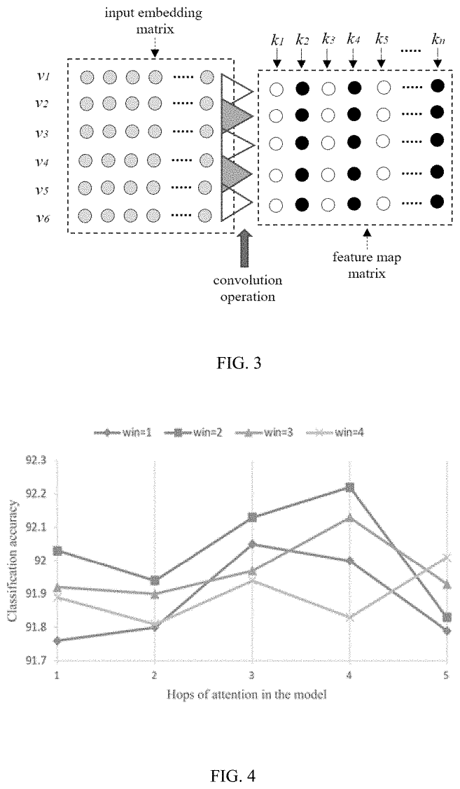

The process of one convolution operation is shown in FIG. 3. The input lexical vector matrix includes 6 lexes (v) and n filters (k) are used, with convolution window set as 2 and sliding step length set as 1.

The followings are experimental analysis on the exemplary embodiments above.

At present, the Chinese tagged corpus for sentiment analysis is not rich, and the general problem is lack of samples and limited fields covered. For the reason that the model proposed in this exemplary embodiment is mainly used for sentiment calculation of Chinese texts in the field, an open Chinese dataset (https://spaces.ac.cn/usr/uploads/2015/08/646864264.zip) including data of six fields is adopted for experiment in this embodiment to effectively complete the training and testing of the model. The six fields involved in such text corpus include book, hotel, computer, milk, cell phone and water heater. The data of each field consist of user comments, and data samples are divided into two categories: positive and negative according to the sentiment polarity. Refer to Table 1 for statistics of experimental data. At last, the data of each field are randomly divided into two parts in equal number according to sentiment polarity, one for training the model as training data and the other one for performance evaluation of the model as testing data.

TABLE 1
Statistics of Experimental Data

| | Category | | | | | | |
|---|---|---|---|---|---|---|---|
| | | | Com- | | Cell | Water | |
| Polarity | Book | Hotel | puter | Milk | phone | heater | Total |
| Positive | 4000 | 2000 | 2000 | 1005 | 1160 | 512 | 10677 |
| Negative | 4000 | 2000 | 2000 | 1170 | 1158 | 100 | 10428 |

| | |
|---|---|
| Total of data | 21105 |

In this embodiment, the Chinese dataset is segmented with Jieba segmentation tool and the development of MHA-CNN model (multi-hop attention convolution neural network, MHA-CNN, i.e. multi-hop depth model of attention mechanism and convolution neural network) is completed with Keras deep learning framework, and TensorFlow is taken as the back end of operation. In the convolution layer, ReLU function is selected as activation function, with a sliding step length set as 1. Refer to Table 2 for other hyper-parameter settings.

TABLE 2
Hyper-parameter Settings of the Model

| Parameter Item | Parameter Value |
|---|---|
| Dimension of embedding of lexis | 350 |
| Size of convolution kernel window | 1, 2, 3, 4 |
| Number of convolution kernels | 250 |
| Limit of regular terms (L2) | 0.01 |
| mini batch | 32 |
| dropout | 0.25 |

In order to verify the validity of the model proposed in this embodiment, 6 types of typical models are introduced for comparison with MHA-CNN, including some performance baseline approaches and the latest research results. The 7 types of models are tested in the selected open datasets of multiple fields, and the parameters of each model are comprehensively optimized according to actual conditions of the datasets, to obtain the optimum classification accuracy. Refer to Table 3 for final experimental results:

1) CNN: the most basic convolution neural network model, wherein the features obtained after segmentation are regarded as input of the network model, and there is no attention mechanism, so the model cannot be optimized for special targets;

2) LSTM: the most basic LSTM network model, wherein this model can retain the relationship of lexical sequences of the input features, can, to a certain extent, solve the issue of long-distance dependency of sentence, and is widely applied to NLP tasks. There is no attention mechanism, so the model cannot be optimized for special targets;

3) SVM: traditional machine learning method, highly depending on artificial features engineering, showing a performance better than that in the learning method at a medium depth in many tasks and generally used for performance evaluation baseline.

4) ABCNN: integrating attention mechanism with convolution neural network in the sentence-oriented modeling tasks, with a better performance than that in previous studies. In this model, the attention mechanism is applied to convolution layer, so that the model can focus on the weight information of specific targets during the training process and analyze the fine-grained sentiment polarity;

5) ATAE-LSTM: In this model, the attention mechanism is integrated with the LSTM network. Firstly, target vector is spliced with the input features; secondly, attention weight information of state sequence in hidden layer is calculated, weighted, synthesized and then output, so that the fine-grained sentiment classification performance of the traditional LSTM network can be greatly improved;

6) MemNet: In this model, the attention mechanism is integrated with the depth memory network. The classification accuracy of the model is improved steadily via stacking of multiple calculation layers. This model is found to be better in performance than the attention model of LSTM architecture after evaluation, with greatly reduced time cost for training.

TABLE 3
Classification Accuracy of Each Model in Dataset

| Model Name | Classification Accuracy |
|---|---|
| CNN | 0.9136 |
| LSTM | 0.9083 |
| SVM | 0.9147 |
| ABCNN | 0.9162 |
| ATAE-LSTM | 0.9173 |
| MemNet | 0.9168 |
| MHA-CNN | 0.9222 |

It can be seen from the experimental results in Table 3 that the classification accuracy of CNN model is 0.9136, the classification accuracy of LSTM model is 0.9083 and the classification accuracy of SVM model is 0.9147. The least scores are taken from the three traditional methods, and it indicates that the results of classification in SVM model based on features are better than those in general depth model. However, with attention mechanism added, the classification accuracy of ABCNN model is 0.9162 and the classification accuracy of ATAE-LSTM model is 0.9173, both significantly improved in performance than the traditional models. It can thus be seen that with introduction of attention mechanism, the model can indeed optimize the specific target field information during the training process, focus on some targets and explore more hidden sentiment features information. This can also show the effective action of the attention mechanism in the task of target-oriented fine-grained sentiment classification.

In the MemNet model, only the simple neural network is integrated with the attention mechanism in each calculation layer, with a classification accuracy of 0.9168 that is equivalent to ABCNN and ATAE-LSTM in performance. This verifies the effectiveness of depth structure with multiple layers stacked to explore hidden features and to optimize the classification performance. The final MHA-CNN model proposed in this embodiment has the best performance, with a classification accuracy of 0.9222. This model, like the MemNet model, adopts the multi-hop attention calculation structure. However, in this model, the input combined multi-dimensional features information is obtained by convolution layer, so that the model can be optimized in performance. Compared with ABCNN model and ATAE-LSTM model, the MHA-CNN model can achieve a better effect of classification, which proves that the multi-hop memory network combined with the attention mechanism can better explore deeper hidden sentiment information for task objects, and effectively solve the issue of long-distance dependency.

In order to verify the previous assumptions about importance of semantic expressions of adjacent lexes and also take into account the effect of the multi-hop attention structure on performance of the model, in this exemplary embodiment, multiple kinds of convolution windows and different numbers of hops of attention calculation are selected in the selected open dataset for experiment, with results shown in FIG. 4, in which win represents the convolution window.

It can be seen from FIG. 4 that the model's classification accuracy in the selected dataset keeps improving along with the increase in number of hops of attention calculation no matter which kind of convolution window is selected. With convolution window set as 1, the best performance of the model occurs in the attention calculation layer of hop 3; with convolution window set as 2 and 3, the best performance of the model occurs in the attention calculation layer of hop 4; with convolution window set as 4, the best performance of the model occurs in the attention calculation layer of hop 5. It can thus be seen that the multi-hop structure may have a critical effect on performance of the model. The model can realize the expansion in a very easy manner via stacking of attention calculation layers and integrate to the end-to-end neural network model in an expandable manner as the attention calculation modules in each hop are completely same. Moreover, along with the continuous increase in number of hops, the scale of parameters in the model will show an explosive growth, which will bring about over-fitting risk to the model and result in a drop in performance.

The performance of the task model is directly affected by the features' capability of semantic expressions. In this embodiment, the combined multi-dimensional features are built by setting different convolution sliding windows and experiment is carried out with attention mechanism. The results in FIG. 6 indicate that when sliding window is set as 1, the highest classification accuracy is 0.9205; when sliding window is set as 2, the best classification accuracy achieved is 0.9222; when sliding window is set as 3, the highest classification accuracy is set as 0.9213. It can thus be seen that in the experiment, the features of phrases formed via convolution with 2 or 3 adjacent lexes have a better capability of semantic expressions than single lexis. Finally, with sliding window set as 4, the classification accuracy of the model drops to 0.9201, which proves that combination of too many adjacent lexes in the Chinese context will bring about a risk of semantic fuzziness. Moreover, the optimum selection of size of convolution sliding window shall flexibly depend on the specific context of application.

An effective end-to-end training can be executed in the entire model. Compared with the LSTM network based on the attention mechanism, this model can save time cost for training and can retain the local lexical sequence information of the features. Finally, the experiment is carried out in an open Chinese dataset (including six types of field data) on a network. The experimental results indicate that this model has a better effect of classification than general depth network model, LSTM model based on attention mechanism and depth memory network model based on attention mechanism, and, via stacking of multiple calculation layers, can effectively improve the performance of classification.

This exemplary embodiment, aiming at the issue of field-oriented fine-grained sentiment classification, discloses a multi-hop attention and depth model integrating convolution neural network with memory network. The model can make use of the features of semantic expressions by adjacent lexes in the Chinese context and use combined multi-dimensional features as a supplement to the attention mechanism with one-dimensional features. Moreover, with an architecture overlapped with multiple calculation layers, the model can also obtain deeper features information of target sentiments, and effectively solve the issue of long-distance dependency. Finally, a comparative experiment is carried out in the open Chinese dataset on the network including six types of field data, and the validity of the model proposed in this embodiment is verified by the experimental results. This model not only has a better performance of classification than general depth network model and depth model based on attention mechanism, but also has an obvious superiority in time cost for training than depth network model of LSTM architecture.

Another exemplary embodiment of the invention discloses a method for classification of target sentiments by use of multi-hop attention and depth model, wherein the information similar to that in the embodiments above is not repeated hear, and inputs of the model include lexical vector matrix (matrx1) and target lexical vector (aspect) (lexical vector matrix (matrx1) represented as V={V₁, V₂, V₃, . . . , Vₙ}). Said method comprises the following steps:

S11: calculating the attention weight vector of the lexical vector matrix (matrix1) for target lexical vector (aspect), wherein the attention weight vector is represented as α={α₁, α₂, α₃, . . . , αₙ};

S12: executing operation ⊗ for lexical vector matrix (matrix1) and obtained attention weight vector to obtain attention-weighted lexical vector matrix (matrix2), wherein operation ⊗ is defined as: V⊗α={α₁·V₁, α₂·V₂, α₃·V₃, . . . , αₙ·Vₙ};

S13: executing the one-dimensional convolution operation for the attention-weighted lexical vector matrix (matrix2), to generate vector matrix of weighted combined adjacent lexical features (matrix4);

S21: executing the one-dimensional convolution operation for the lexical vector matrix (matrix1), to generate vector matrix of combined adjacent lexical features (matrix3);

S22: calculating attention in multiple hops, wherein the same calculation mode is adopted for attention calculation in each hop, including:

S221: calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation, wherein the first attention calculation is for the attention weight vector of the target lexical vector (aspect) while the rest of the attention calculations are for new target lexical vector (aspect′) output from the previous attention calculation (hopm−1);

S222: executing the operation ⊙ for the vector matrix of combined adjacent lexical features (matrix3) and attention weight vector obtained in step S221, to obtain attention weight and vector, wherein operation ⊙ is defined as: V⊙α=V·α=Σᵢ₌₁ⁿαᵢ·Vₙ;

S223: executing operation ⊕ for the attention weight vector obtained in step S222 and the target lexical vector (aspect), or executing operation ⊕ for the attention weight vector obtained in step S02 and the attention weight vector of new target lexical vector (aspect′) output from the previous attention calculation (hopm−1), wherein the operation ⊕ is defined as: α⊕β=α+β; the first attention calculation (hop1) is for the target lexical vector (aspect) while the rest of the attention calculations (hopm) are for new target lexical vector (aspect′) output from the previous attention calculation (hopm−1);

Said method further includes:

S31: calculating the attention weight vector of vector matrix of weighted combined adjacent lexical features (matrix4) for new target lexical vector (aspect′) output from the last attention calculation (hop);

S32: executing the operation ⊙ for the vector matrix of weighted combined adjacent lexical features (matrix4) and attention weight vector obtained in step S31, to obtain attention weight and vector;

S33: representing the attention weight and vector obtained in step S32 as the final vector of input text, wherein the predict outcomes for classification of sentiments can be obtained through this fully connected layer.

Preferably, in this embodiment, any calculation mode for calculating the attention weight vector of lexical vector matrix for target lexical vector or calculating attention weight vector of feature vector matrix for target lexical vector is:

$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$

Where W represents target lexical vector, V represents lexical vector matrix or feature vector matrix, U represents weight matrix and b represents offset vector;

After this, SoftMax function is used for normalization of correlation scores of all inputs, and the originally calculated scores are converted into a probability distribution with the sum of weights of all elements being 1:

$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$

Where exp represents an exponential function with e as base.

Preferably, in this embodiment, said method further includes:

Pre-training the lexes in the input texts by means of word2vec or Glove algorithm and converting them into lexical vectors, and then forming a two-dimension matrix with the lexical vectors in a lexical order to obtain the lexical vector matrix (matrix1).

Preferably, in this embodiment, said one-dimensional convolution operation comprises:

Sliding multiple filters k on the whole line of the lexical vector matrix, to finally generate the feature vector representing adjacent poly-lexical combinations in the sliding window, i.e. the vector matrix of combined adjacent lexical features, with a calculation formula of:

FM=ƒ(w·x+b)

Where w represents weight matrix of filter, x represents lexical vector matrix input in the filter window, b represents offset and f represents activation function of filter.

Another exemplary embodiment of the invention discloses a storage medium, storing computer instructions, wherein the steps of a method for classification of target sentiments by use of multi-hop attention and depth model are executed when said computer instructions are executed.

Another exemplary embodiment of the invention discloses a terminal, including a storage medium and a processor, computer instructions that can be operated in the processor are stored in the storage medium, wherein the steps of a method for classification of target sentiments by use of multi-hop attention and depth model are executed when said computer instructions are executed by said processor.

Based on this understanding, essence of technical scheme in this embodiment or contributions of the technical scheme to the existing technologies or parts of the technical scheme can be represented in a form of software products, wherein such software products are stored in a storage medium, including multiple instructions for AP to execute all or part of the steps of the method in each embodiment of the invention. Said storage medium includes: USB flash drive, mobile hard disk drive, read-only memory (ROM), Random access memory (RAM), diskette or CD and other media available for storage of program codes.

What is claimed:

1. A multi-hop attention and depth model for classification of target sentiments, with inputs including lexical vector matrix (matrx1) and target lexical vector (aspect) (lexical vector matrix (matrx1) represented as V={V₁, V₂, V₃, . . . , Vₙ}), wherein said model includes:
a first convolution operation module, for executing one-dimensional convolution operation to lexical vector matrix (matrix1) to generate vector matrix of combined adjacent lexical features (matrix3);
a first attention calculation module, for calculating the attention weight vector of the lexical vector matrix (matrix1) for target lexical vector (aspect), wherein the attention weight vector is represented as α={α₁, α₂, α₃, . . . , αₙ};
a lexical vector weighting module, for executing operation ⊗ for the lexical vector matrix (matrix1) with the obtained attention weight vector, to obtain the attention-weighted lexical vector matrix (matrix2), wherein the operation ⊗ is defined as:
V⊗α={α₁·V₁,α₂·V₂,α₃·V₃, . . . ,αₙ·V₁};
a second convolution operation module, for executing the one-dimensional convolution operation for the attention-weighted lexical vector matrix (matrix2), to generate vector matrix of weighted combined adjacent lexical features (matrix4);
multiple attention calculation layers (hop) connected in sequence, wherein all of the attention calculation layers (hop) are in the same structure, including:
an attention calculation unit, for calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation layer (hop), wherein the first attention calculation layer (hop1) is for the attention weight vector of the target lexical vector (aspect) while the rest of the attention calculation layers (hopm) are for new target lexical vector (aspect′) output from the previous attention calculation layer (hopm−1).
an attention weighting unit, for executing the operation ⊙ for the vector matrix of combined adjacent lexical features (matrix3) and attention weight vector obtained by the attention calculation unit, to obtain attention weight and vector, wherein operation ⊙ is defined as: V⊙α=V·α=Σᵢ₌₁ⁿαᵢ·Vₙ;
a new target lexical vector generation unit, for executing operation ⊕ for the attention weight vector obtained by the attention weighting unit and the target lexical vector (aspect), or executing operation ⊕ for the attention weight vector obtained by the attention weighting unit and the attention weight vector of new target lexical vector (aspect′) output from the previous attention calculation layer (hop), wherein the operation ⊕ is defined as: α⊕β=α+β; the first attention calculation layer (hop1) is for the target lexical vector (aspect) while the rest of the attention calculation layers (hopm) are for new target lexical vector (aspect′) output from the previous attention calculation layer (hopm−1);
said model also includes:
a second attention calculation module, for calculating the attention weight vector of vector matrix of weighted combined adjacent lexical features (matrix4) for new target lexical vector (aspect′) output from the last attention calculation layer (hop);
an attention weighting module, for executing operation ⊙ for vector matrix of weighted combined adjacent lexical features (matrix4) and attention weight vector obtained by the second attention calculation module, to obtain attention weight and vector;
a fully connected layer, for representing the attention weight and vector output from the attention weighting module as the final vector of input text, wherein the predict outcomes for classification of sentiments can be obtained through this fully connected layer.

2. The multi-hop attention and depth model for classification of target sentiments according to claim 1, wherein any calculation mode for calculating the attention weight vector of lexical vector matrix for target lexical vector or calculating attention weight vector of feature vector matrix for target lexical vector is:
$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$
where W represents target lexical vector, V represents lexical vector matrix or feature vector matrix, U represents weight matrix and b represents offset vector;
after this, SoftMax function is used for normalization of correlation scores of all inputs, and the originally calculated scores are converted into a probability distribution with the sum of weights of all elements being 1:
$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$
where exp represents an exponential function with e as base.

3. The multi-hop attention and depth model for classification of target sentiments according to claim 1, wherein said model further includes:
a pre-processing module, for pre-training the lexes in the input texts by means of word2vec or Glove algorithm and converting them into lexical vectors, and then forming a two-dimension matrix with the lexical vectors in a lexical order to obtain the lexical vector matrix (matrix1).

4. The multi-hop attention and depth model for classification of target sentiments according to claim 1, wherein the one-dimensional convolution operation of said convolution operation module comprises:
sliding multiple filters k on the whole line of the lexical vector matrix, to finally generate the feature vector representing adjacent poly-lexical combinations in the sliding window, i.e. the vector matrix of combined adjacent lexical features, with a calculation formula of:
FM=ƒ(w·x+b)
where w represents weight matrix of filter, x represents lexical vector matrix input in the filter window, b represents offset and f represents activation function of filter.

5. A method for classification of target sentiments by use of multi-hop attention and depth model with inputs including lexical vector matrix (matrx1) and target lexical vector (aspect) (lexical vector matrix (matrx1) represented as V={V₁, V₂, V₃, . . . , Vₙ}), wherein said method comprises the following steps:
S11: calculating the attention weight vector of the lexical vector matrix (matrix1) for target lexical vector (aspect), wherein the attention weight vector is represented as α={α₁, α₂, φ₃, . . . , αₙ};
S12: executing operation ⊗ for lexical vector matrix (matrix1) and obtained attention weight vector to obtain attention-weighted lexical vector matrix (matrix2), wherein operation ⊗ is defined as: V⊙α={α₁·V₁, α₂·V₂, α₃·V₃, . . . , αₙ·Vₙ};
S13: executing the one-dimensional convolution operation for the attention-weighted lexical vector matrix (matrix2), to generate vector matrix of weighted combined adjacent lexical features (matrix4);
S21: executing the one-dimensional convolution operation for the lexical vector matrix (matrix1), to generate vector matrix of combined adjacent lexical features (matrix3);
S22: calculating attention in multiple hops, wherein the same calculation mode is adopted for attention calculation in each hop, including:
S221: calculating the attention weight vector of vector matrix of combined adjacent lexical features (matrix3) for the target lexical vector (aspect), or calculating the attention weight vector of vector matrix of combined adjacent lexical features (matrix3) for the new target lexical vector (aspect′) output from the previous attention calculation, wherein the first attention calculation is for the attention weight vector of the target lexical vector (aspect) while the rest of the attention calculations are for new target lexical vector (aspect′) output from the previous attention calculation (hopm−1);
S222: executing the operation ⊙ for the vector matrix of combined adjacent lexical features (matrix3) and attention weight vector obtained in step S221, to obtain attention weight and vector, wherein operation ⊙ is defined as: V⊙α=V·α=Σᵢ₌₁ⁿαᵢ·Vₙ;
S223: executing operation ⊕ for the attention weight vector obtained in step S222 and the target lexical vector (aspect), or executing operation ⊕ for the attention weight vector obtained in step S02 and the attention weight vector of new target lexical vector (aspect′) output from the previous attention calculation (hopm−1), wherein the operation ⊕ is defined as: α⊕β=α+β; the first attention calculation (hop1) is for the target lexical vector (aspect) while the rest of the attention calculations (hopm) are for new target lexical vector (aspect′) output from the previous attention calculation (hopm−1);
said method further includes:
S31: calculating the attention weight vector of vector matrix of weighted combined adjacent lexical features (matrix4) for new target lexical vector (aspect′) output from the last attention calculation (hop);
S32: executing the operation ⊙ for the vector matrix of weighted combined adjacent lexical features (matrix4) and attention weight vector obtained in step S31, to obtain attention weight and vector;
S33: representing the attention weight and vector obtained in step S32 as the final vector of input text, wherein the predict outcomes for classification of sentiments can be obtained through this fully connected layer.

6. The method for classification of target sentiments by use of multi-hop attention and depth model according to claim 5, wherein any calculation mode for calculating the attention weight vector of lexical vector matrix for target lexical vector or calculating attention weight vector of feature vector matrix for target lexical vector is:
$$fatt ( V , W ) = \{ \begin{matrix}{W}^{T} V \\ tanh ( {U}_{α} [ W ; V ] + {b}_{α} ) \\ \frac{{W}^{T} V}{‖ W ‖ \cdot ‖ V ‖}\end{matrix} ;$$
where W represents target lexical vector, V represents lexical vector matrix or feature vector matrix, U represents weight matrix and b represents offset vector;
after this, SoftMax function is used for normalization of correlation scores of all inputs, and the originally calculated scores are converted into a probability distribution with the sum of weights of all elements being 1:
$${α}_{i} = softmax ( {f}_{att} ( {V}_{i} , W ) ) = \frac{exp ( {f}_{att} ( {V}_{i} , W ) )}{{\sum }_{j = 1}^{n} exp ( {f}_{att} ( {V}_{j} , W ) )}$$
where exp represents an exponential function with e as base.

7. The method for classification of target sentiments by use of multi-hop attention and depth model according to claim 5, wherein said method further includes:
pre-training the lexes in the input texts by means of word2vec or Glove algorithm and converting them into lexical vectors, and then forming a two-dimension matrix with the lexical vectors in a lexical order to obtain the lexical vector matrix (matrix1).

8. The method for classification of target sentiments by use of multi-hop attention and depth model according to claim 5, wherein said one-dimensional convolution operation comprises:
sliding multiple filters k on the whole line of the lexical vector matrix, to finally generate the feature vector representing adjacent poly-lexical combinations in the sliding window, i.e. the vector matrix of combined adjacent lexical features, with a calculation formula of:
FM=ƒ(w·x+b)
Where w represents weight matrix of filter, x represents lexical vector matrix input in the filter window, b represents offset and f represents activation function of filter.

9. (canceled)

10. (canceled)
